(19) United States
(12) Patent Application Publication
(10) Pub. No.: US 2010/0001025 A1
(43) Pub. Date: Jan. 7, 2010

(54) DISPENSER AND METHOD OF USING AND MANUFACTURING

(76) Inventor: Corey James McCormick, Mesa, AZ (US)

Correspondence Address: SCHMEISER OLSEN & WATTS, 18 E UNIVERSITY DRIVE, SUITE # 101, MESA, AZ, 85201, US

(21) Appl. No.: 12/507,607

(22) Filed: Jul. 22, 2009

(51) Int. Cl. B65D 37/00; B23P 19/04

(52) U.S. Cl. 222/206; 29/700; 222/207

(57) ABSTRACT

A dispenser includes a resilient dispenser body with an aperture and an attachment mechanism coupled to the resilient dispenser body. Liquid is dispensed through the aperture in response to pressing the resilient dispenser body. In particular, liquid is dispensed through the aperture in response to flexing the resilient dispenser body at a position away from the aperture.

### BACKGROUND OF THE INVENTION

1. Field of the Invention

This invention relates generally to a dispenser which can be positioned at a desired location.

2. Description of the Related Art

It is highly desirable to avoid germs to reduce the likelihood of becoming sick. Most germs are transferred through physical contact, such as by touching a surface that carries the germ. It is useful to clean ones hand, such as with a sanitizer, to reduce the likelihood of germs being transferred. The sanitizer can be in the form of a liquid that is stored in a dispenser. However, it is often inconvenient to carry sanitizer in a dispenser.

There are many different types of dispensers, such as a hand dispenser. A hand dispenser dispenses a liquid, such as the sanitizer, onto a person's hand. Some types of hand dispensers are attached to a fixture, and are not meant to be carried from one location to another. Other types of hand dispensers are in the form of bottles which are meant to be carried by a person. However, bottle dispensers can be lost or forgotten, which makes it more difficult to clean ones hands to avoid germs.

### BRIEF SUMMARY OF THE INVENTION

The present invention is directed to a dispenser. The novel features of the invention are set forth with particularity in the appended claims. The invention will be best understood from the following description when read in conjunction with the accompanying drawings.

### BRIEF DESCRIPTION OF THE DRAWINGS

FIGS. 1a and 1b are perspective and side views of a dispenser.

FIGS. 1c and 1d are front and back views of the dispenser of FIGS. 1a and 1b.

FIGS. 2a and 2b are front and back perspective views, respectively, of a rigid dispenser body of the dispenser of FIGS. 1a and 1b.

FIG. 3a is a perspective view of an embodiment of a resilient dispenser body of the dispenser of FIGS. 1a and 1b, wherein the resilient dispenser body is embodied as a resilient cover.

FIG. 3b is a perspective view of an embodiment of a resilient dispenser body of the dispenser of FIGS. 1a and 1b, wherein the resilient dispenser body is embodied as a bladder.

FIGS. 4a, 4b and 4c are perspective, side and front views, respectively, of another embodiment of a dispenser.

FIGS. 5a and 5b are front and perspective views, respectively, of the dispenser of FIGS. 1a and 1b attached to a support structure.

FIG. 6a is a perspective view of the dispenser of FIGS. 5a and 5b attached to the support structure, wherein the resilient dispenser body is being pressed by a finger.

FIG. 6b is a perspective view of the dispenser of FIGS. 5a and 5b attached to the support structure, wherein the resilient dispenser body is being pressed by a thumb.

FIG. 6c is a perspective view of the dispenser of FIGS. 5a and 5b attached to the support structure, wherein the resilient dispenser body is being pressed by a palm.

FIGS. 7a, 7b and 7c are flow diagrams of methods of assembling a dispenser.

### DETAILED DESCRIPTION OF THE INVENTION

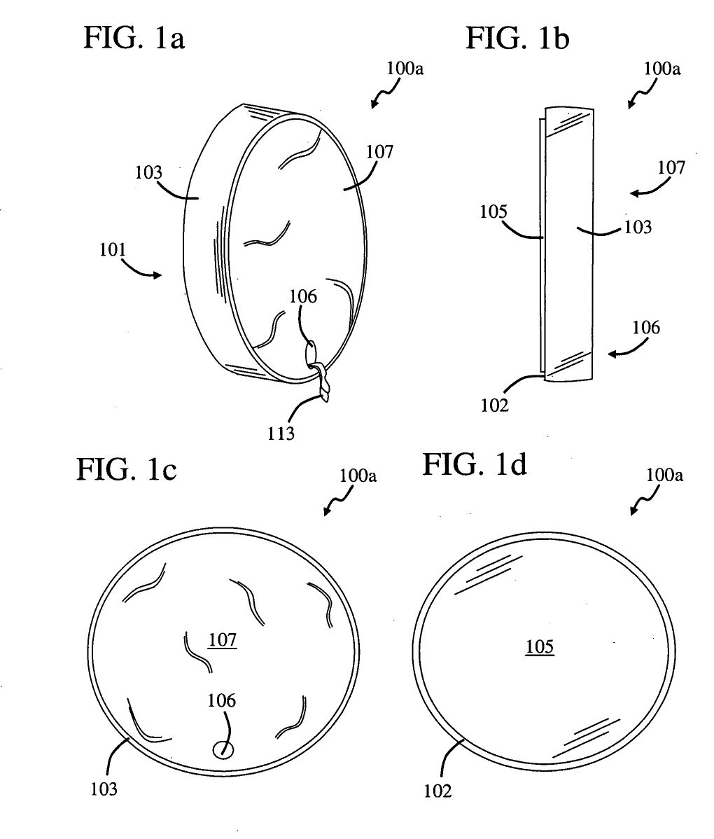

FIGS. 1a and 1b are perspective and side views of a dispenser 100a, and FIGS. 1c and 1d are front and back views of dispenser 100a. In this embodiment, dispenser 100a includes a rigid dispenser body 101 and resilient dispenser body 107 coupled together. It should be noted that rigid dispenser body 101 includes a material that is more rigid than the material of resilient dispenser body 107, and resilient dispenser body 107 includes a material that is less rigid than the material of rigid dispenser body 101. Further, it should be noted that resilient dispenser body 107 includes a material that is more resilient than the material of rigid dispenser body 101, and rigid dispenser body 101 includes a material that is less resilient than the material of resilient dispenser body 107. The material of rigid dispenser body 101 and resilient dispenser body 107 can be of many different types, such as plastic and rubber.

In this embodiment, resilient dispenser body 107 includes an aperture 106 for dispensing a liquid 113, as will be discussed in more detail below. Liquid 113 can be of many different types, such as a sanitizer. In some embodiments, aperture 106 operates as a one-way valve which allows liquid 113 to flow therethrough in response to pressing resilient dispenser body 107. In some embodiments, aperture 106 is repeatably moveable between open and closed conditions in response to pressing resilient dispenser body 107.

In operation, dispenser 100a dispenses liquid 113 through aperture 106 in response to pressing resilient dispenser body 107. Liquid 113 is dispensed through aperture 106 in response to pressing resilient dispenser body 107 at a position away from aperture 106. It should be noted that resilient dispenser body 107 flexes in response to being pressed. In particular, resilient dispenser body 107 flexes inwardly in response to being pressed. It should also be noted that, in some embodiments, resilient dispenser body 107 is translucent so that the amount of liquid held by dispenser 100a can be seen therethrough.

In this embodiment, dispenser 100a includes an attachment mechanism 105 coupled to rigid dispenser body 101. Attachment mechanism 105 allows rigid dispenser body 101 to be repeatably coupled to and decoupled from the support structure. In this way, attachment mechanism 105 allows rigid dispenser body 101 to be attached to a support structure at a desired location.

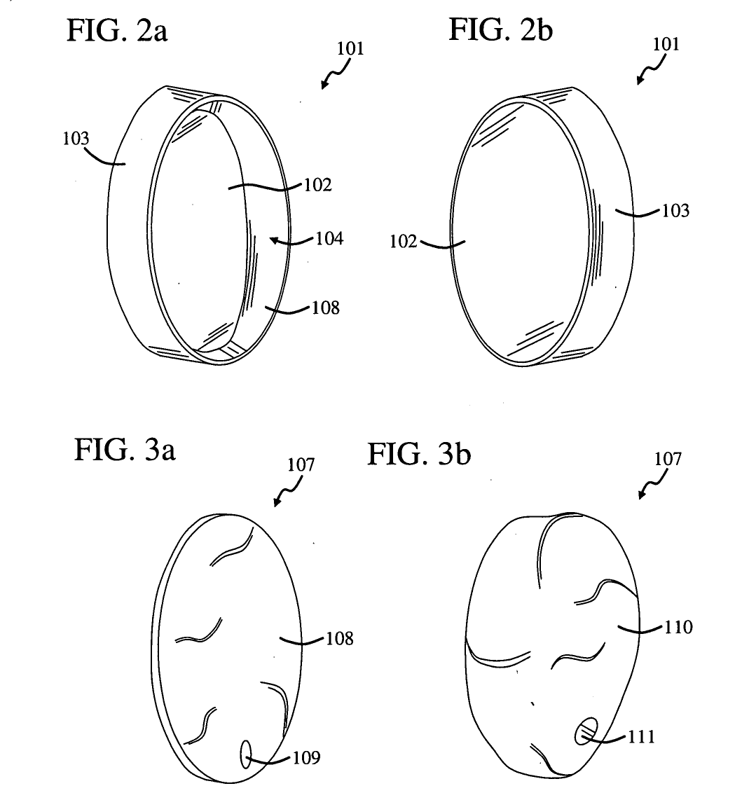

FIGS. 2a and 2b are front and back perspective views, respectively, of rigid dispenser body 101. In this embodiment, rigid dispenser body 101 includes a backwall 102, and a sidewall 103 extending around the outer periphery of backwall 102 to form a rigid dispenser body cavity 104. It should be noted that rigid dispenser body cavity 104 holds liquid 113 which is dispensed by aperture 106.

Attachment mechanism 105 extends over backwall 102, as shown in FIG. 1d. Attachment mechanism 105 generally includes an adhesive material which allows attachment mechanism 105 to be adhered to backwall 102 and the support structure, as will be discussed in more detail below.

FIG. 3a is a perspective view of resilient dispenser body 107 embodied as a resilient cover 108. In this embodiment, aperture 106 is embodied as a resilient cover aperture 109, which is included with resilient cover 108. Liquid 113 is held in rigid dispenser body cavity 104 between rigid dispenser body 101 and resilient cover 108. Further, liquid 113 is dispensed through resilient cover aperture 109 in response to pressing resilient cover 108. Liquid 113 is dispensed from resilient cover aperture 109 in response to pressing resilient cover 108 at a position away from resilient cover aperture 109. It should be noted that resilient cover 108 flexes in response to being pressed. In particular, resilient cover 108 flexes inwardly in response to being pressed. It should also be noted that, in some embodiments, resilient cover 108 is translucent so that the amount of liquid held by the dispenser can be seen therethrough.

Resilient cover 108 is repeatably moveable between coupled and decoupled positions with rigid dispenser body 101. Resilient cover 108 is repeatably moveable between coupled and decoupled positions with rigid dispenser body 101 so that dispenser 100a can be refilled. Dispenser 100a is refilled by removing resilient cover 108 and flowing liquid 113 into rigid dispenser body cavity 104. Resilient cover 108 is coupled to rigid dispenser body 101 so that liquid 113 is held in rigid dispenser body cavity 104 between rigid dispenser body 101 and resilient cover 108. Dispenser 100a can be refilled many times by repeatably moving resilient cover 108 between coupled and decoupled positions with rigid dispenser body 101.

FIG. 3b is a perspective view of resilient dispenser body 107 embodied as a bladder 110. In this embodiment, aperture 106 is embodied as a bladder aperture 111, which is included with bladder 110. Liquid 113 is held by bladder 110 and is dispensed through bladder aperture 111 in response to pressing bladder 110. Liquid 113 is dispensed from bladder aperture 111 in response to pressing bladder 110 at a position away from bladder aperture 111. It should be noted that bladder 110 flexes in response to being pressed. In particular, bladder 110 flexes inwardly in response to being pressed. It should also be noted that, in some embodiments, bladder 110 is translucent so that the amount of liquid held by the dispenser can be seen therethrough.

Bladder 110 is repeatably moveable between coupled and decoupled positions with rigid dispenser body 101. In particular, bladder 110 is repeatably moveable between coupled and decoupled positions with backwall 102 in rigid dispenser body cavity 104. Bladder 110 is repeatably moveable between coupled and decoupled positions with rigid dispenser body 101 so that dispenser 100a can be refilled. Dispenser 100a is refilled by decoupling bladder 111 from rigid dispenser body 101 and replacing it with another bladder. Dispenser 100a can be refilled many times by repeatably decoupling a bladder from rigid dispenser body 101 and replacing it with another bladder.

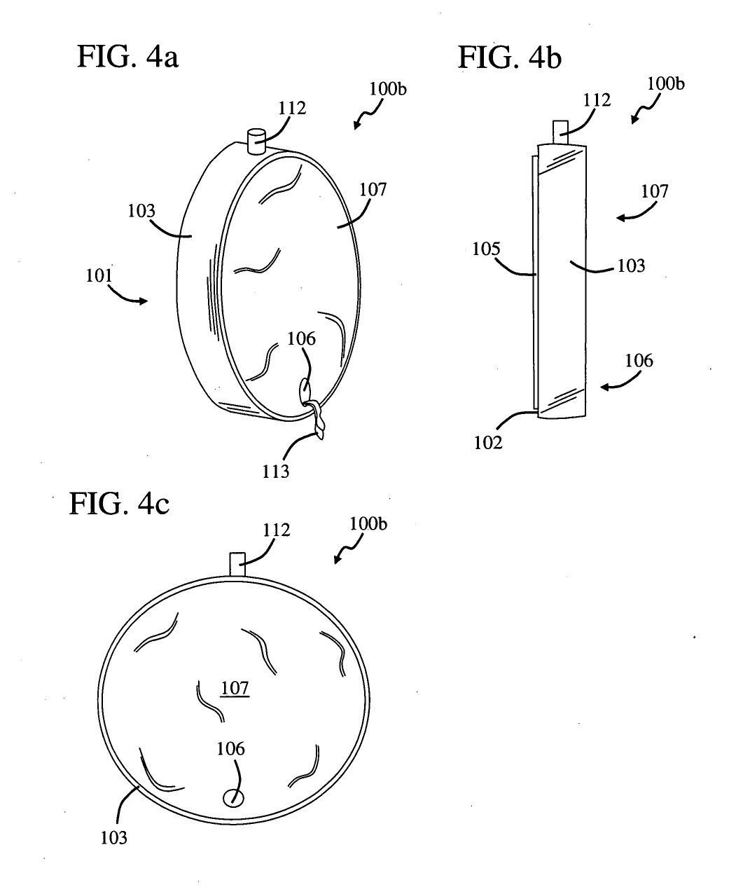

FIGS. 4a, 4b and 4c are perspective, side and front views, respectively, of a dispenser 100b. In this embodiment, dispenser 100b includes rigid dispenser body 101 and resilient dispenser body 107 coupled together. Resilient dispenser body 107 includes aperture 106 for dispensing liquid 113. Dispenser 100b dispenses liquid 113 through aperture 106 in response to pressing resilient dispenser body 107. In some embodiments, aperture 106 operates as a one-way valve which allows liquid 113 to flow therethrough in response to pressing resilient dispenser body 107.

In this embodiment, dispenser 100b includes attachment mechanism 105 coupled to rigid dispenser body 101. Attachment mechanism 105 allows rigid dispenser body 101 to be repeatably coupled to and decoupled from the support structure. In this way, attachment mechanism 105 allows rigid dispenser body 101 to be attached to a support structure at a desired location.

In this embodiment, resilient dispenser body 107 is coupled to rigid dispenser body 101 so it is not repeatably removeable therefrom, as in dispenser 100a. It should be noted that, in some embodiments, resilient dispenser body 107 and aperture 106 are embodied as resilient cover 108 and resilient cover aperture 109, respectively. In the embodiments in which resilient dispenser body 107 and aperture 106 are embodied as resilient cover 108 and resilient cover aperture 109, respectively, resilient cover 108 is coupled to rigid dispenser body 101 so it is not repeatably removeable therefrom, as in dispenser 100a.

Further, in other embodiments, resilient dispenser body 107 and aperture 106 are embodied as bladder 110 and bladder aperture 111, respectively. In the embodiments in which resilient dispenser body 107 and aperture 106 are embodied as bladder 110 and bladder aperture 111, respectively, bladder 110 is coupled to rigid dispenser body 101 so it is not repeatably removeable therefrom, as in dispenser 100a.

In this embodiment, dispenser 100b includes a nozzle 112 which allows dispenser 100b to be refilled. In some embodiments, nozzle 112 extends through sidewall 103 and is in fluid communication with rigid dispenser body cavity 104. For example, in the embodiments in which resilient dispenser body 107 and aperture 106 are embodied as resilient cover 108 and resilient cover aperture 109, respectively, nozzle 112 is in fluid communication with rigid dispenser body cavity 104 and allows the flow of liquid 113 into rigid dispenser body cavity 104. In this way, dispenser 100b is refilled.

In the embodiments in which resilient dispenser body 107 and aperture 106 are embodied as bladder 110 and bladder aperture 111, respectively, nozzle 112 is in fluid communication with bladder 110 and allows the flow of liquid 113 into bladder 110. In this way, dispenser 100b is refilled. In some of these embodiments, nozzle 112 can be integral with bladder 110.

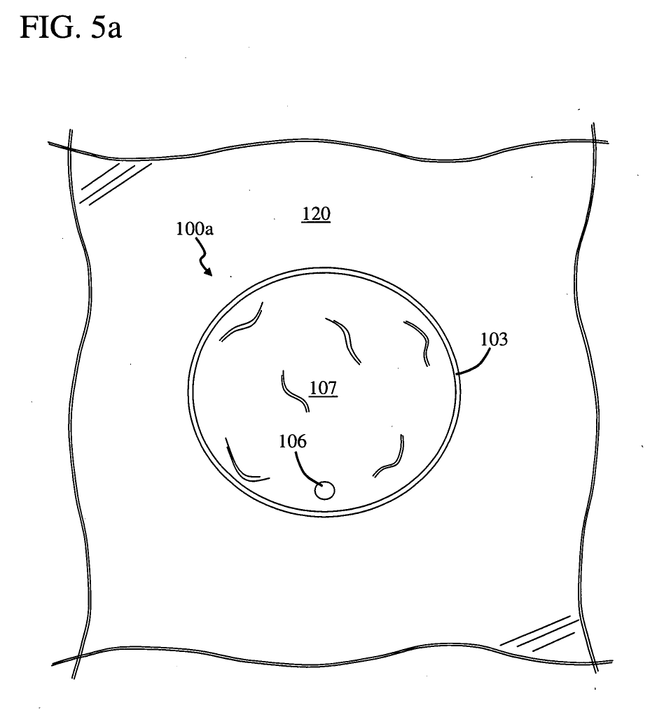

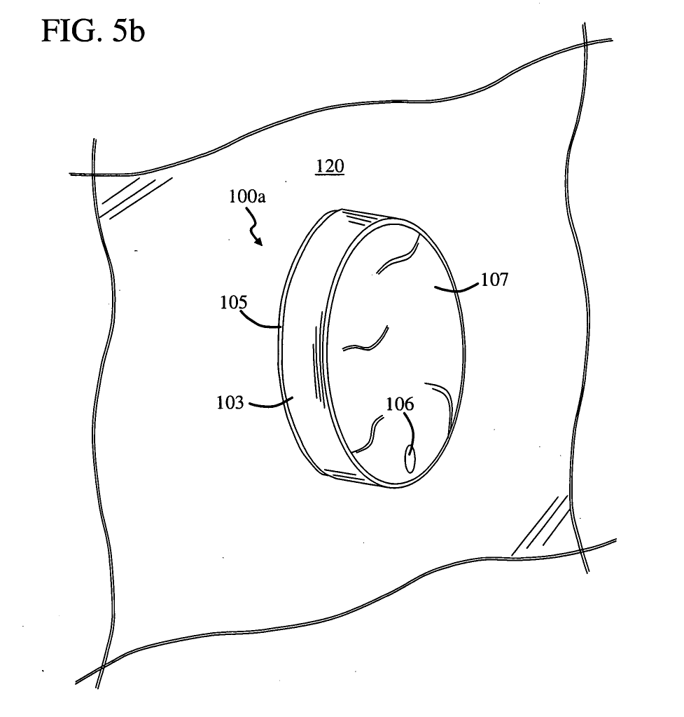

FIGS. 5a and 5b are front and perspective views, respectively, of dispenser 100a attached to a support structure 120. As shown in FIG. 5b, dispenser 100a is attached to support structure 120 by attachment mechanism 105. It should be noted that dispenser 100a can be detached from support structure 120 and attached to another support structure, if desired. In this way, the location of dispenser 100a can be changed.

Support structure 120 can be of many different types of support structures, such as a wall, door, etc. The wall can be at many different locations, such as proximate to a door knob. Positioning dispenser 100a proximate to a door knob is useful so that a person can dispense liquid 113 therefrom. It is well-known that a person can be exposed to germs in response to touching the door knob. As mentioned above, liquid 113 is dispensed in response to pressing resilient dispenser body 107. Resilient dispenser body 107 can be pressed in many different ways to dispense liquid 113, several of which will be discussed in more detail presently.

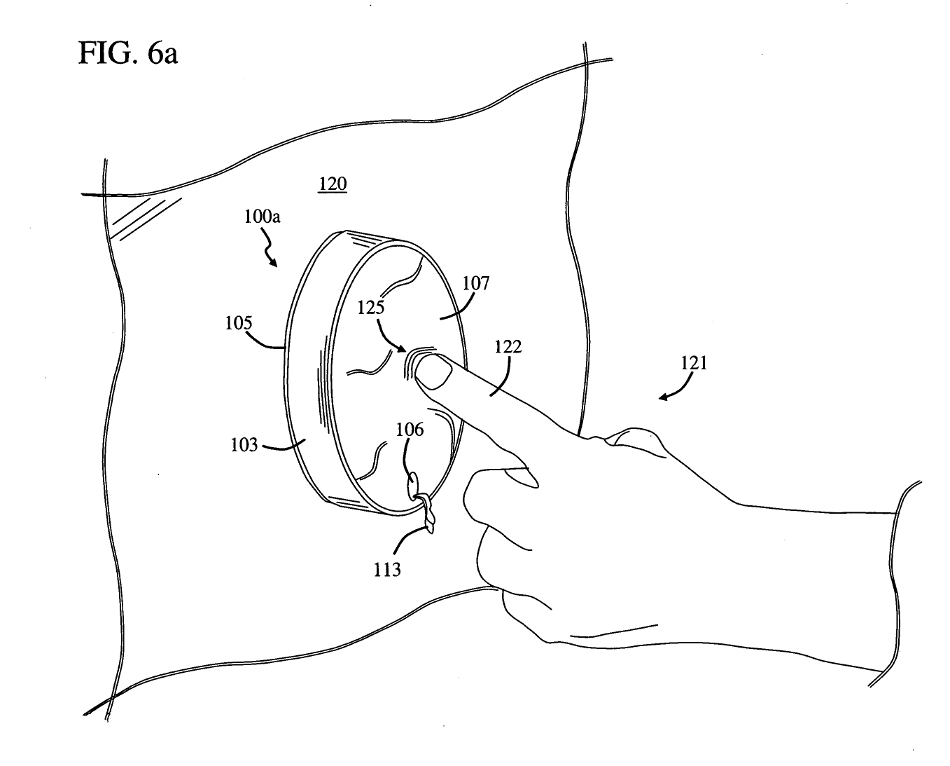

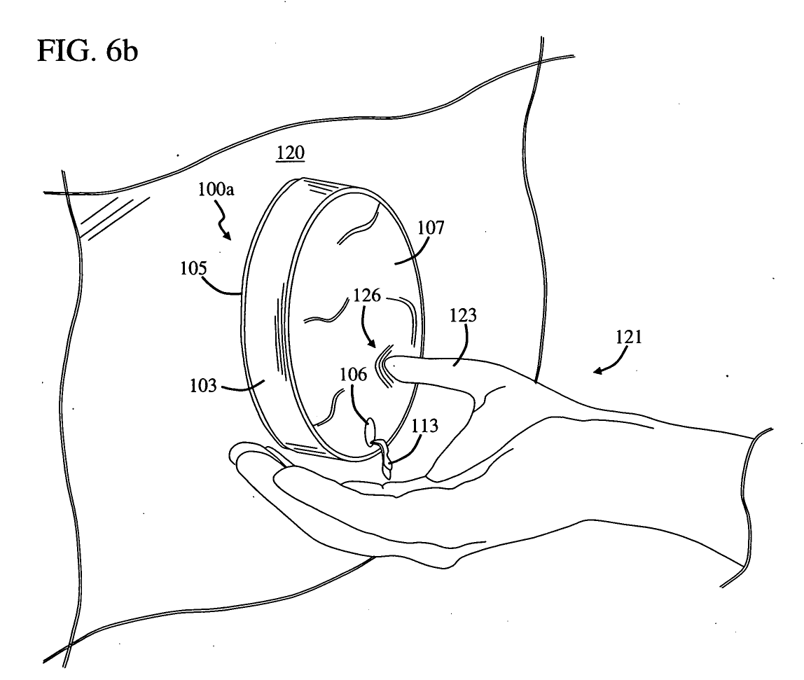

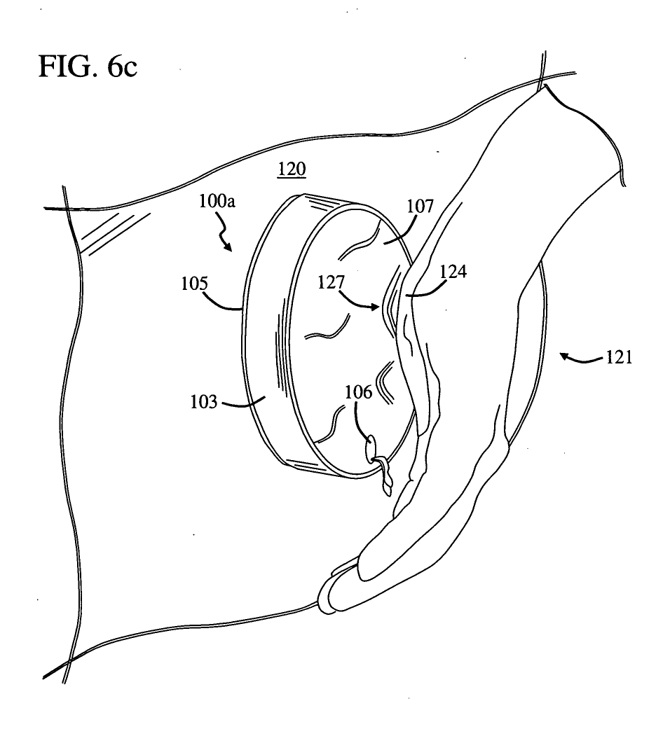

FIG. 6a is a perspective view of dispenser 100a attached to support structure 120. In this situation, liquid 113 is dispensed in response to pressing resilient dispenser body 107 with a finger 122 of a hand 121. In particular, liquid 113 is dispensed in response to pressing resilient dispenser body 107 at a position 125 with finger 122, wherein position 125 is away from aperture 106. Liquid 113 is restricted from being dispensed by aperture 106 when resilient dispenser body 107 is not pressed with finger 122. Liquid 113 is dispensed from aperture 106 in response to pressing resilient dispenser body 107 with finger 122 away from aperture 106. It should be noted that resilient dispenser body 107 flexes in response to being pressed with finger 122. In particular, resilient dispenser body 107 flexes inwardly in response to being pressed with finger 122.

FIG. 6b is a perspective view of dispenser 100a attached to support structure 120. In this situation, liquid 113 is dispensed in response to pressing resilient dispenser body 107 with a thumb 123 of hand 121. In particular, liquid 113 is dispensed in response to pressing resilient dispenser body 107 at a position 126 with thumb 123, wherein position 126 is away from aperture 106. Liquid 113 is restricted from being dispensed by aperture 106 when resilient dispenser body 107 is not pressed with thumb 123. Liquid 113 is dispensed from aperture 106 in response to pressing resilient dispenser body 107 with thumb 123 away from aperture 106. It should be noted that resilient dispenser body 107 flexes in response to being pressed with thumb 123. In particular, resilient dispenser body 107 flexes inwardly in response to being pressed with thumb 123. It should also be noted that, in some situations, position 126 is the same position as position 125 and, in other situations, position 126 is not same position as position 125.

FIG. 6c is a perspective view of dispenser 100a attached to support structure 120. In this situation, liquid 113 is dispensed in response to pressing resilient dispenser body 107 with a palm 124 of hand 121. In particular, liquid 113 is dispensed in response to pressing resilient dispenser body 107 at a position 127 with palm 124, wherein position 127 is away from aperture 106. Liquid 113 is restricted from being dispensed by aperture 106 when resilient dispenser body 107 is not pressed with palm 124. Liquid 113 is dispensed from aperture 106 in response to pressing resilient dispenser body 107 with palm 124 away from aperture 106. It should be noted that resilient dispenser body 107 flexes in response to being pressed with palm 124. In particular, resilient dispenser body 107 flexes inwardly in response to being pressed with palm 124. It should also be noted that, in some situations, position 127 is the same position as position 125 and, in other situations, position 126 is not same position as position 125. Further, in some situations, position 127 is the same position as position 126 and, in other situations, position 126 is not same position as position 126. Hence, liquid 113 can be dispensed by using different portions of hand 121. Further, liquid 113 can be dispensed by using pressing different portions of resilient dispenser body 107 with the same portions of hand 121 and with different portions of hand 121.

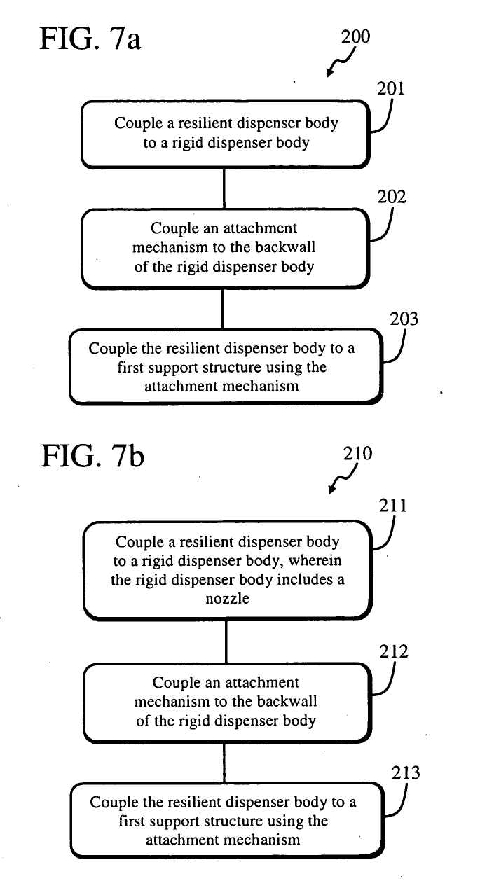

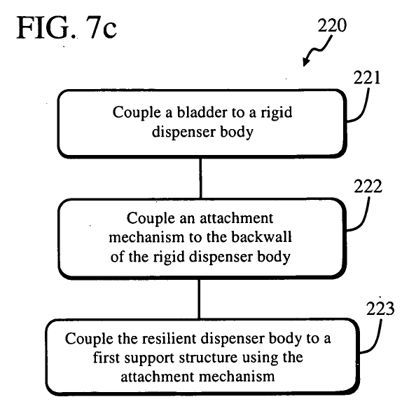

FIG. 7a is a flow diagram of a method 200 of assembling a dispenser. In this embodiment, method 200 includes a step 201 of coupling a resilient dispenser body to a rigid dispenser body. The resilient dispenser body includes an aperture and the rigid dispenser body includes a backwall and a sidewall extending therefrom to form a rigid dispenser body cavity. Method 200 includes a step 202 of coupling an attachment mechanism to the backwall of the rigid dispenser body. Method 200 includes a step 203 of coupling the resilient dispenser body to a first support structure using the attachment mechanism.

Method 200 can include many other features. For example, in some embodiments, the aperture restricts the liquid from being dispensed in response to the resilient dispenser body being unflexed.

Method 200 can include many other steps. For example, in some embodiments, method 200 includes a step of flowing a liquid into the rigid dispenser body cavity. The liquid can be of many different types, such as a hand sanitizer.

In some embodiments, method 200 includes a step of flexing the resilient dispenser body to dispense the liquid through the aperture. The resilient dispenser body can be flexed in many different ways, such as by flexing it with a hand. Many different portions of the hand can be used to flex the resilient dispenser body. For example, the resilient dispenser body can be flexed using a finger, thumb and palm of the hand.

In some embodiments, method 200 includes a step of pressing the resilient dispenser body to dispense the liquid through the aperture. The resilient dispenser body can be pressed in many different ways, such as by pressing it with a hand. Many different portions of the hand can be used to press the resilient dispenser body. For example, the resilient dispenser body can be pressed using a finger, thumb and palm of the hand.

In some embodiments, method 200 includes a step of flexing the resilient dispenser body at a position away from the aperture to dispense the liquid. The resilient dispenser body can be flexed at a position away from the aperture by flexing it with the hand. Many different portions of the hand can be used to flex the resilient dispenser body at the position away from the aperture. For example, the resilient dispenser body can be flexed at the position away from the aperture by using a finger, thumb and palm of the hand.

In some embodiments, method 200 includes a step of pressing the resilient dispenser body at a position away from the aperture to dispense the liquid. The resilient dispenser body can be pressed at a position away from the aperture by pressing it with the hand. Many different portions of the hand can be used to press the resilient dispenser body at the position away from the aperture. For example, the resilient dispenser body can be pressed at the position away from the aperture by using a finger, thumb and palm of the hand.

In some embodiments, method 200 includes a step of decoupling the resilient dispenser body from the first support structure, and coupling the resilient dispenser body to a second support structure. In this way, the location of the dispenser can be changed.

FIG. 7b is a flow diagram of a method 210 of assembling a dispenser. In this embodiment, method 210 includes a step 211 of coupling a resilient dispenser body to a rigid dispenser body. The resilient dispenser body includes an aperture and the rigid dispenser body includes a backwall and a sidewall extending therefrom to form a rigid dispenser body cavity. The rigid dispenser body includes a nozzle which extends through the sidewall. Method 210 includes a step 212 of coupling an attachment mechanism to the backwall of the rigid dispenser body. Method 210 includes a step 213 of coupling the resilient dispenser body to a first support structure using the attachment mechanism.

Method 210 can include many other features. For example, in some embodiments, the aperture restricts the liquid from being dispensed in response to the resilient dispenser body being unflexed. In some embodiments, the dispenser includes a bladder in fluid communication with the nozzle.

Method 210 can include many other steps. For example, in some embodiments, method 210 includes a step of flowing a liquid into the rigid dispenser body cavity. The liquid can be of many different types, such as a hand sanitizer.

In some embodiments, method 210 includes a step of flexing the resilient dispenser body to dispense the liquid through the aperture. The resilient dispenser body can be flexed in many different ways, such as by flexing it with a hand. Many different portions of the hand can be used to flex the resilient dispenser body. For example, the resilient dispenser body can be flexed using a finger, thumb and palm of the hand.

In some embodiments, method 210 includes a step of pressing the resilient dispenser body to dispense the liquid through the aperture. The resilient dispenser body can be pressed in many different ways, such as by pressing it with a hand. Many different portions of the hand can be used to press the resilient dispenser body. For example, the resilient dispenser body can be pressed using a finger, thumb and palm of the hand.

In some embodiments, method 210 includes a step of flexing the resilient dispenser body at a position away from the aperture to dispense the liquid. The resilient dispenser body can be flexed at a position away from the aperture by flexing it with the hand. Many different portions of the hand can be used to flex the resilient dispenser body at the position away from the aperture. For example, the resilient dispenser body can be flexed at the position away from the aperture by using a finger, thumb and palm of the hand.

In some embodiments, method 210 includes a step of pressing the resilient dispenser body at a position away from the aperture to dispense the liquid. The resilient dispenser body can be pressed at a position away from the aperture by pressing it with the hand. Many different portions of the hand can be used to press the resilient dispenser body at the position away from the aperture. For example, the resilient dispenser body can be pressed at the position away from the aperture by using a finger, thumb and palm of the hand.

In some embodiments, method 210 includes a step of decoupling the resilient dispenser body from the first support structure, and coupling the resilient dispenser body to a second support structure. In this way, the location of the dispenser can be changed.

FIG. 7c is a flow diagram of a method 220 of assembling a dispenser. In this embodiment, method 220 includes a step 221 of coupling a bladder to a rigid dispenser body. The bladder includes a bladder aperture and the rigid dispenser body includes a backwall and a sidewall extending therefrom to form a rigid dispenser body cavity. The bladder extends through the rigid dispenser body cavity.

Method 220 includes a step 222 of coupling an attachment mechanism to the backwall of the rigid dispenser body. Method 220 includes a step 223 of coupling the resilient dispenser body to a first support structure using the attachment mechanism.

Method 220 can include many other features. For example, in some embodiments, the bladder aperture restricts the liquid from being dispensed in response to the resilient dispenser body being unflexed. In some embodiments, the dispenser includes a nozzle which extends through the sidewall and is in fluid communication with the bladder.

Method 220 can include many other steps. For example, in some embodiments, method 220 includes a step of flowing a liquid into the bladder through the nozzle. The liquid can be of many different types, such as a hand sanitizer.

In some embodiments, method 220 includes a step of flexing the bladder to dispense the liquid through the bladder aperture. The bladder can be flexed in many different ways, such as by flexing it with a hand. Many different portions of the hand can be used to flex the bladder. For example, the bladder can be flexed using a finger, thumb and palm of the hand.

In some embodiments, method 220 includes a step of pressing the bladder to dispense the liquid through the bladder aperture. The bladder can be pressed in many different ways, such as by pressing it with a hand. Many different portions of the hand can be used to press the bladder. For example, the bladder can be pressed using a finger, thumb and palm of the hand.

In some embodiments, method 220 includes a step of flexing the bladder at a position away from the bladder aperture to dispense the liquid. The bladder can be flexed at a position away from the bladder aperture by flexing it with the hand. Many different portions of the hand can be used to flex the bladder at the position away from the bladder aperture. For example, the bladder can be flexed at the position away from the bladder aperture by using a finger, thumb and palm of the hand.

In some embodiments, method 220 includes a step of pressing the bladder at a position away from the bladder aperture to dispense the liquid. The bladder can be pressed at a position away from the bladder aperture by pressing it with the hand. Many different portions of the hand can be used to press the bladder at the position away from the bladder aperture. For example, the bladder can be pressed at the position away from the bladder aperture by using a finger, thumb and palm of the hand.

In some embodiments, method 220 includes a step of decoupling the bladder from the first support structure, and coupling the bladder to a second support structure. In this way, the location of the dispenser can be changed.

The embodiments of the invention described herein are exemplary and numerous modifications, variations and rearrangements can be readily envisioned to achieve substantially equivalent results, all of which are intended to be embraced within the spirit and scope of the invention as defined in the appended claims.

1. A dispenser, comprising:
a resilient dispenser body with an aperture;
an attachment mechanism coupled to the resilient dispenser body;
wherein liquid is dispensed through the aperture in response to pressing the resilient dispenser body.

2. The dispenser of claim 1, further including a rigid dispenser body, wherein the attachment mechanism is coupled to the resilient dispenser body through the rigid dispenser body.

3. The dispenser of claim 1, wherein the aperture operates as a one-way valve which allows the liquid to flow therethrough in response to pressing the resilient dispenser body.

4. The dispenser of claim 1, wherein the attachment mechanism allows the resilient dispenser body to be repeatably coupled to and decoupled from a support structure.

5. The dispenser of claim 1, wherein the resilient dispenser body is a bladder.

6. The dispenser of claim 1, wherein the resilient dispenser body is a resilient cover.

7. The dispenser of claim 1, wherein the liquid is dispensed from the aperture in response to pressing the resilient dispenser body at a position away from the aperture.

8. A dispenser, comprising:
a rigid dispenser body having a backwall and a sidewall extending therefrom to form a rigid dispenser body cavity;
a resilient dispenser body with an aperture, wherein the resilient dispenser body covers the rigid dispenser body cavity;
an attachment mechanism coupled to the backwall;
wherein the dispenser dispenses liquid through the aperture in response to the resilient dispenser body being flexed.

9. The dispenser of claim 8, wherein the liquid is dispensed from the aperture in response to flexing the resilient dispenser body at a position away from the aperture.

10. The dispenser of claim 8, wherein the aperture is repeatably moveable between open and closed conditions in response to flexing the resilient dispenser body.

11. The dispenser of claim 8, further including a nozzle which extends through the rigid dispenser body.

12. The dispenser of claim 11, wherein the resilient dispenser body is a bladder in fluid communication with the nozzle.

13. The dispenser of claim 8, wherein the resilient dispenser body is a resilient cover which is repeatable moveable between coupled and uncoupled positions with the rigid dispenser body.

14. A method, comprising:
coupling a resilient dispenser body to a rigid dispenser body, wherein the resilient dispenser body includes an aperture and the rigid dispenser body includes a backwall and a sidewall extending therefrom to form a rigid dispenser body cavity;
coupling an attachment mechanism to the backwall;
coupling the resilient dispenser body to a first support structure using the attachment mechanism.

15. The method of claim 14, further including flowing a liquid into the rigid dispenser body cavity.

16. The method of claim 15, wherein the aperture restricts the liquid from being dispensed in response to the resilient dispenser body being unflexed.

17. The method of claim 14, further including flexing the resilient dispenser body to dispense the liquid through the aperture.

18. The method of claim 14, further including pressing the resilient dispenser body to dispense the liquid through the aperture.

19. The method of claim 14, further including flexing the resilient dispenser body at a position away from the aperture to dispense the liquid.

20. The method of claim 14, further including decoupling the resilient dispenser body from the first support structure, and coupling the resilient dispenser body to a second support structure.
